(19) United States
(12) Patent Application Publication
(10) Pub. No.: US 2006/0207396 A1
(43) Pub. Date: Sep. 21, 2006

(54) Lathe, and Machining System Equipped with the Lathe

(75) Inventors: Kazuyuki Hiramoto, Yamatokoriyama-shi, Nara (JP); Toshio Ueda, Yamatokoriyama-shi, Nara (JP)

Correspondence Address: JUDGE & MURAKAMI IP ASSOCIATES, DOJIMIA BUILDING, 7TH FLOOR, 6-8 NISHITEMMA 2-CHOME, KITA-KU, OSAKA-SHI, 530-0047, JP

(73) Assignee: MORI SEIKI CO., LTD., Yamatokoriyama-shi (JP)

(21) Appl. No.: 11/306,215

(22) Filed: Dec. 20, 2005

(30) Foreign Application Priority Data
Dec. 22, 2004 (JP) JP-2004-371855
Feb. 21, 2005 (JP) JP-2005-043582
Feb. 21, 2005 (JP) JP-2005-043626

(51) Int. Cl. B23B 3/00

(52) U.S. Cl. 82/117

(57) ABSTRACT

A lathe includes a bed, a main spindle that holds one end side of a workpiece, a headstock that supports the main spindle such that its axis is horizontal and it can rotate about its axis, and that is disposed on the bed such that it can move in the main spindle axial direction, a rotational drive mechanism for rotating the main spindle about its axis, a tailstock fixedly disposed on the bed in opposition to the headstock, a tailstock spindle that is supported by the tailstock such that it is coaxial with the main spindle, and that supports the other end side of the workpiece, tool posts that hold tools and that are disposed on the bed such that they can move in the main spindle axial direction, and a feed mechanism for moving the headstock and the tool posts in the various directions.

### BACKGROUND OF THE INVENTION

1. Technical Field

The present invention relates to lathes that are provided with a main spindle that holds one end of a workpiece, a headstock that rotatively supports the main spindle, a tailstock that is disposed in opposition to the headstock and that supports the other end of the workpiece, and a tool post that holds a tool, and machining systems that are made of at least two such lathes.

2. Description of the Related Art

One conventional example of such a lathe is disclosed in JP H5-200601A, in which, as shown in FIG. 7 and FIG. 8, a lathe 100 is made of a bed 101 whose front face is tilted, a headstock 102 fixedly provided on the slanted front face of the bed 101, a main spindle 103 that is supported by the headstock 102 in such a manner that it can rotate about its axis, a tailstock 105 that is disposed on the slanted front face of the bed 101 in such a manner that it can move in the axial direction of the main spindle 103 (the arrow direction in FIG. 7), a tailstock spindle 106 that is supported by the tailstock 105 in such a manner that it can move in its axial direction, a saddle 107 that is disposed on the slanted front face of the bed 101 in such a manner that it can move in the axial direction of the main spindle 103, and a first and a second tool post 108 and 109 for holding tools T, each of which is disposed on the saddle 107 in such a manner that it can move perpendicular to the main spindle 103 axis (the arrow direction in FIG. 8). It should be noted that FIG. 7 is a front view schematically showing the configuration of this conventional lathe, and FIG. 8 is a side view of the lathe shown in FIG. 7.

The main spindle 103 is provided with a chuck 104 that holds one end of a workpiece W, its axis is disposed horizontally, and it is rotated about its axis by a rotational drive mechanism (not shown) integral to the headstock 102. The tailstock spindle 106 is disposed coaxial with the main spindle 103 and supports the other end of the workpiece W, and is moved in the axial direction by a hydraulic mechanism (not shown) that is provided in the tailstock 105.

The tailstock 105 and the saddle 107 are moved in the main spindle 103 axial direction by feed mechanisms 110 and 111 provided with drive motors 110a and 111a and ball screws 110b and 111b, respectively, and the first tool post 108 and the second tool post 109 similarly are moved in the direction that is perpendicular to the main spindle 103 axis by feed mechanisms 112 and 113 that are provided with drive motors 112a and 113a and ball screws (not shown), respectively.

With the lathe 100 having this configuration, first the chuck 104 of the main spindle 103 holds one end of the workpiece W, and then the tailstock 105 is moved in the main spindle 103 axial direction by the feed mechanism 110 to abut the tailstock spindle 106 of the tailstock 105 against the other end of the workpiece W. Next, the hydraulic mechanism (not shown) is actuated to move the tailstock spindle 106 toward the main spindle 103, but since the tailstock spindle 106 cannot move toward the main spindle 103, it is pressed against the other end of the workpiece W with a predetermined force, and thus the other end of the workpiece W is supported by the tailstock spindle 106.

The workpiece W is machined into a predetermined shape when it is rotated by the rotational drive mechanism (not shown) rotating the main spindle 103 about its axis and the first tool post 108 or the second tool post 109 are moved in a predetermined feed direction by the feed mechanism 111, 112, or 113. It should be noted that chips produced by machining the workpiece W fall downward along the slanted front face of the bed 101 and are collected by a suitable collection mechanism (not shown).

However, with the above conventional lathe 100, the operator can only perform various tasks, such as attaching and detaching workpieces W, from the front face side of the bed 101, and thus not only is this unfavorable in terms of work efficiency but it also places restrictions on how the lathe 100 is arranged in the factory.

Further, when performing maintenance, it is necessary to perform maintenance on all of the structural elements, including the headstock 102, the tailstock 105, the saddle 107, the first tool post 108, and the second tool post 109, and thus the work region is large and this is not efficient.

Between the headstock 102 and the tailstock 105, the headstock 102 has the more complex structure than the tailstock 105, and the tailstock 105 is designed such that it can move whereas the headstock 102 is fixedly provided to the bed 101, and as a result the tailstock 105 is less rigid than the headstock 102. Thus, there is the problem that the tailstock spindle 106 axis will tilt or that the tailstock 105 will strain when the tailstock spindle 106 is pressed against the other end side of the workpiece W, lowering the machining accuracy of the workpiece W.

When a plurality of such conventional lathes 100 are provided parallel in the front-to-back direction, there must be a working space for the operator on the front face side of the bed 101, and thus it is necessary to provide the lathes 100 parallel at a constant spacing in order to secure a working space on the front face side of each bed 101, and this requires a wide area for installation.

Further, if the entire outer circumferential surface of the workpiece W is to be machined, for example, then the portion that is held by the chuck 104 of the main spindle 103 cannot be machined, and it is therefore necessary to machine the workpiece W dividing the work between a first process of machining a predetermined region on the tailstock spindle 106 side of the workpiece W and a second process of machining the unmachined region, which includes the portion held by the chuck 104 in the first process.

When performing such machining, the entire outer circumference of the workpiece W is machined by a machining system made of two lathes 100 such as described above, a conveying device for conveying the workpiece W, and a workpiece inverting device for inverting the workpiece W.

In this machining system, the lathes 100 are lined up in the axial direction of the main spindles 103, and one lathe 100 performs the first process and the other lathe 100 performs the second process. Further, the conveying device is provided with a grasping mechanism for grasping the workpiece W, and by moving that grasping mechanism (workpiece) along a predetermined conveying route in a straight line in three-dimensional space, the conveying device can perform a first operation of grasping a workpiece W in a suitable outside location (unmachined workpiece W placing portion) with the grasping mechanism and conveying it so that it is held by the main spindle 103 of the one lathe 100, a second operation of grasping the workpiece W that is held by the main spindle 103 of the one lathe 100 with the grasping mechanism and then conveying it so that it is held by the main spindle 103 of the other lathe 100, and a third operation of grasping the workpiece W that is held by the main spindle 103 of the other lathe 100 with the grasping mechanism and conveying it to a suitable outside location (a machined workpiece W placing portion).

It should be noted that the workpiece inverting device inverts the workpiece W by 180°, and is attached to the grasping mechanism of the conveying device or is provided on the path over which the grasping mechanism moves during the second operation of the conveying device.

With this machining system, the end portion of the workpiece W that has been machined by the one lathe 100 can be held by the main spindle 103 of the other lathe 100 by inverting the workpiece W with the workpiece inverting device while conveying the workpiece W from the one lathe 100 to the other lathe 100 with the conveying device, and thus the first process can be executed by the one lathe 100 and the second process can be executed by the other lathe 100.

However, providing a workpiece inverting device to invert the workpiece W increases the overall size of the machining system and the overall size of the grasping mechanism of the conveying device, and this raises production costs.

### BRIEF SUMMARY OF THE INVENTION

The present invention was arrived at in light of the foregoing issues, and it is an object thereof to provide a lathe that is efficient for operators to use, that has a flexible layout, and that allows high accuracy machining to be performed, as well as a machining system that is provided with at least two such lathes, that allows the lathes to be disposed in a small installation area, that allows the structural elements to be kept small in size, and that allows production costs to be curtailed.

The present invention for achieving the foregoing objects is a lathe comprising a bed; a headstock installed on the bed; a main spindle, supported by the headstock such that the main spindle axis is horizontal, and allowing the main spindle to rotate on the axis as center, the main spindle for holding a workpiece along one end thereof; a rotational drive mechanism for rotating the main spindle on its axis as center; a tailstock arranged on the bed in opposition to the headstock; a tailstock spindle, supported by the tailstock such that it is coaxial with the main spindle axis, for supporting the workpiece along the other end thereof; a tool post for holding tools, arranged on the bed so as to be moveable along the main spindle axis and so as to be moveable perpendicular to the main spindle axis; and a tool post feed mechanism for moving the tool post in each of the directions; wherein the headstock is configured to be moveable along the main spindle axis, whereas the tailstock is fixedly installed on the bed; and the headstock is configured for being moved along the main spindle axis by a headstock feed mechanism.

With this lathe, for example, by first pushing the other end side of the workpiece against the tailstock spindle of the tailstock and then moving the headstock along the main spindle axis with the headstock feed mechanism to hold the workpiece along one end thereof with the main spindle, the workpiece is held sandwiched between the main spindle and the tailstock spindle. Then, by rotating the main spindle on its axis as center with the rotational drive mechanism to rotate the workpiece and also moving the tool post in a predetermined feed direction with the tool post feed mechanism, the workpiece is machined into a predetermined shape.

Further, in this invention, since the tailstock, which has a more simple structure than the headstock and its shape is not as large, is fixedly installed on the bed, the operator can perform various tasks, such as attaching and removing the workpiece, from the tailstock side as well, and this allows work efficiency to be improved and allows the limitations that are in effect when arranging the lathe to be made as small as possible, giving greater flexibility to its layout.

When performing maintenance on the lathe, the tailstock is fastened to the bed and thus it is possible to obviate maintenance of that section of the tailstock, therefore reducing the area that is to be maintenanced and allowing maintenance to be performed more efficiently.

Further, since the tailstock that is fixedly installed on the bed is less rigid than the headstock and it is the headstock that is moved, the rigidity of the tailstock can be increased, and tilting of the tailstock spindle axis and straining of the tailstock due to the force when pressing the other end side of the workpiece against the tailstock spindle are effectively prevented, and this allows the workpiece to be machined more precisely.

It should be noted that it is also possible for the bed to be formed rectangularly in overhead view, and to be formed with at least the external conformation of a vertical section widthwise through the bed being symmetrical on either side of a predetermined vertical plane of symmetry; and the headstock and the tailstock are arranged on the upper surface of the bed such that the axes of the main spindle and the tailstock spindle are included in the plane of symmetry.

With this configuration, the distance from the lateral faces on both sides in the bed width direction to the center (plane of symmetry), that is, the axes of the main spindle and the tailstock spindle, are equal, and this allows the outer shape of the lathe to be made compact, and thus an operator can similarly perform various tasks from either side in the bed width direction. Thus, operator work efficiency is further improved and the layout of the lathe within the factory can be made even more flexible.

It is also possible for the bed to be provided with a chip discharge hollow formed vertically and opening in the bed upper surface between the headstock and the tailstock, and is provided with four insertion recesses formed extending horizontally, one side of each communicated with the lower part of the chip discharge hollow, and the other side of each open on one of the lateral sides of the bed; therein further comprising: a chip collection means for collecting chips, the chip collection means inserted through any one of the bed-lateral-side openings in the four insertion recesses to dispose the chip collection means beneath the chip discharge hollow.

With this configuration, the chips that are produced in conjunction with machining the workpiece fall downward through the chip discharge hollow and land in and are collected by the chip collection means that has been inserted through an insertion recess, and since an insertion recess is opened on each of the four lateral sides of the bed, the insertion recess into which the chip collection means is inserted can be suitably changed to fit the layout of the lathe, and this allows even greater flexibility in how the lathe is arranged.

It is also possible for the lathe to further include a cover member surrounding the headstock, the tailstock, the tool post, and at least the bed upper surface, the cover member being furnished in its upper surface with a door for forming an opening, and with this configuration, not only can the chips and cutting fluid be prevented from spattering outside the lathe by the cover member, but the operator can open the door and perform various tasks from the opening in the upper surface of the cover member. It should be noted that in this case it is necessary to set the upper face of the bed to a low height and to set the lathe to an overall low height.

It is also possible that the opening in the cover member to be formed such that the distances to the plane of symmetry from the endfaces on either side of the opening in the bed widthwise orientation are equal, and to be formed extending from the above said tailstock to the opposite side thereof. With this configuration, tasks can be performed through the opening with ease from either side in the bed width direction and from the tailstock side of the bed, and thus the operator can perform tasks efficiently.

The invention also relates to a machining system equipped with at least two lathe, wherein: the lathes are disposed rowed in parallel such that their main spindles axes are parallel and spaced apart by a predetermined distance.

With this machining system, as described above, the operator can perform tasks from the tailstock side of the bed as well, and lathes provided with a bed that is formed rectangularly in overhead view are disposed rowed in parallel so that the axes of their main spindles are parallel and spaced apart by a predetermined distance, and thus the spacing between lathes can be made suitably small, and by reducing this spacing it is possible to reduce the area of the region in which the machining system is installed.

The invention also relates to a machining system comprising: two lathes, a first lathe and a second lathe, and a conveying device, furnished with a grasping mechanism for grasping workpieces, the conveying device for moving the grasping mechanism in three-dimensional space to convey workpieces to the lathes; wherein the first lathe and the second lathe are disposed with either the lateral sides of the beds on the headstock side of each or the lateral sides of the beds on the tailstock side of each facing each other, and such that the axes of their respective main spindles are coaxial; and the conveying device is configured to perform: a first operation of grasping with the grasping mechanism a workpiece outside the first lathe and conveying the workpiece so as to allow the workpiece to be held by the main spindle of the first lathe; a second operation of grasping with the grasping mechanism the workpiece held by the main spindle of the first lathe and conveying the workpiece so as to allow the workpiece to be held by the main spindle of the second lathe; and a third operation of grasping with the grasping mechanism the workpiece held by the second lathe and conveying the workpiece to outside the second lathe.

With this machining system, first the conveying device performs the first operation of grasping an unmachined workpiece outside the first lathe with the grasping mechanism and conveying the workpiece so that it is held by the main spindle of the first lathe, and the headstock is moved along the main spindle axis by the headstock feed mechanism of the first lathe, and by doing this, the workpiece along one end thereof is held by the main spindle and the workpiece along the other end thereof is supported by the tailstock spindle, sandwiching the workpiece between the main spindle and the tailstock spindle, and then a predetermined region of the outer circumferential surface of the workpiece on its other end side (tailstock spindle side) is machined into a predetermined shape.

Next, the conveying device performs the second operation of grasping the workpiece held by the main spindle of the first lathe with the grasping mechanism and conveying the workpiece so that it is held by the main spindle of the second lathe, and the headstock is moved along the main spindle axis by the headstock feed mechanism of the second lathe, and by doing this, the workpiece along the other end thereof is held by the main spindle and the workpiece along one end thereof is supported by the tailstock spindle, sandwiching the workpiece between the main spindle and the tailstock spindle, and then an unmachined region of the outer circumferential surface of the workpiece on its one end side (tailstock spindle side) is machined into a predetermined shape.

Next, the conveying device performs the third operation of grasping the workpiece that is held on the main spindle of the second lathe with the grasping mechanism and conveying it outside the second lathe, and in this way a series of operations for machining the workpiece is performed. It should be noted that when the workpiece is discharged from the first lathe through the second operation of the conveying device, a new unmachined workpiece is supplied to the first lathe through the first operation, and when the workpiece is discharged from the second lathe through the third operation of the conveying device, a new workpiece is supplied to the second lathe through the second operation.

In this machining system, as described above the operator can work from either side in the width direction of the bed, and lathes provided with a bed that is formed rectangularly in overhead view are disposed with either the lateral sides of the beds on the headstock side of each or the lateral sides of the beds on the tailstock side of each facing each other, and such that the axes of their respective main spindles are coaxial, and thus simply by conveying the workpiece with the conveying device, the workpiece end portion that is held by the main spindle and the workpiece end portion that is supported by the tailstock spindle in the first lathe, and the workpiece end portion that is held by the main spindle and the workpiece end portion that is supported by the tailstock spindle in the second lathe, can be made opposite one another.

This obviates the need for a workpiece inverting device and thus allows production costs to be reduced, and also allows the overall size of the device configuration of the machining system and the overall size of the device configuration of the grasping mechanism of the conveying device to be kept small.

It should be noted that it is also possible for each bed to be provided with a chip discharge hollow formed vertically and opening in the bed upper surface between the headstock and the tailstock, and three insertion recesses formed extending horizontally, one side of each communicated with the lower part of the chip discharge hollow, and the other side of each open on one of the bed lateral sides except at least the lateral sides along which the beds oppose each other; and each lathe is further provided with a chip collection means for collecting chips, the chip collection means inserted through any one of the bed-lateral-side openings in the three insertion recesses to dispose the chip collection means beneath the chip discharge hollow.

As mentioned above, by doing this the insertion recess into which the chip collection means is inserted can be suitably changed to fit the layout of the lathe (machining system), and this allows even greater flexibility in how the lathe (machining system) is arranged.

It is also possible for each lathe to further include a cover member surrounding the headstock, the tailstock, the tool post, and at least the bed upper surface, each cover member being furnished in its upper surface with a openable/closable door for forming an opening, and with an open/close mechanism for opening and closing the door; and the open/close mechanism of the first lathe is configured so as to open the door during the first operation and the second operation by the conveying device, and the open/close mechanism of the second lathe is configured so as to open the door during the second operation and the third operation by the conveying device.

As mentioned above, by doing this, the cover member can prevent the chips and the cutting fluid from spattering outside, and the operator can open the door either manually or by actuating the open/close mechanism and then perform various tasks through the opening in the upper surface of the cover member.

It is also possible for the opening in each of the cover members to be formed such that the distances to the plane of symmetry from the endfaces on either side of the opening in the bed widthwise orientation are equal, and by doing this, as mentioned above, tasks can be performed efficiently through the opening with ease from either side in the bed width direction.

It is also possible for the first lathe and the second lathe to be disposed such that the lateral sides of the beds on the tailstock side of each face each other, and by doing this the distance between the tailstocks is reduced, and this allows the distance that the grasping mechanism travels when the conveying device performs the second operation to be shortened, which allows the workpiece to be conveyed in a shorter time.

Thus, the lathe of the invention allows operator workability to be increased, allows a more flexible layout, and moreover, allows the machining accuracy of the workpiece to be increased.

The machining system of the invention allows the spacing at which the lathes are disposed to be reduced so that a plurality of lathes can be disposed in a small installation area, obviates the need for a workpiece inverting device, reduces production costs, and allows the overall size of the machining system and the overall size of the grasping mechanism of the conveying device to be kept small.

### BRIEF DESCRIPTION OF THE SEVERAL VIEWS OF THE DRAWINGS

FIG. 1 is a perspective view schematically showing the configuration of the machining system according to an embodiment of the invention.

FIG. 2 is a perspective view schematically showing the lathe according to this embodiment.

FIG. 3 is a plan view of the lathe shown in FIG. 2.

FIG. 4 is a front view of the lathe shown in FIG. 2.

FIG. 5 is a cross section taken in the arrow A-A direction in FIG. 4.

FIG. 6 is a perspective view schematically showing the configuration of the machining system according to another embodiment of the invention.

FIG. 7 is a plan view showing the schematic configuration of the lathe according to the conventional example.

FIG. 8 is a side view of the lathe shown in FIG. 7.

### DETAILED DESCRIPTION OF THE INVENTION

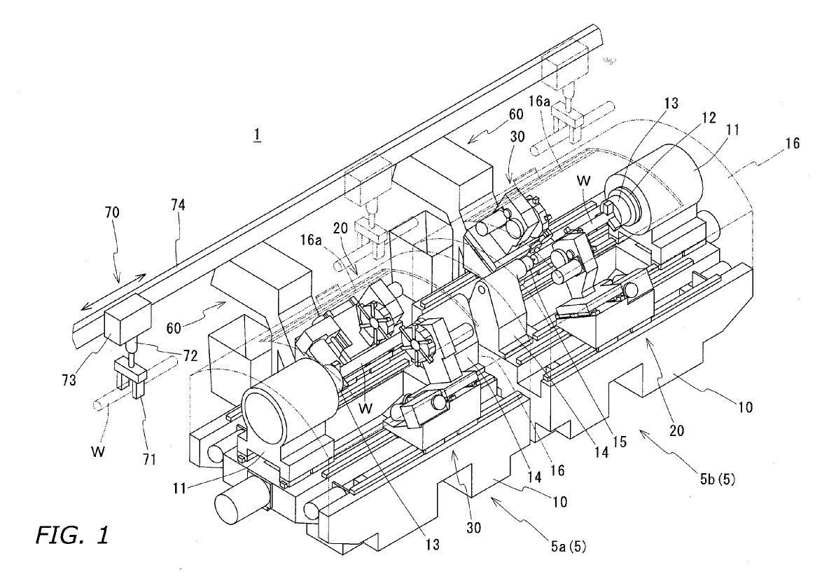

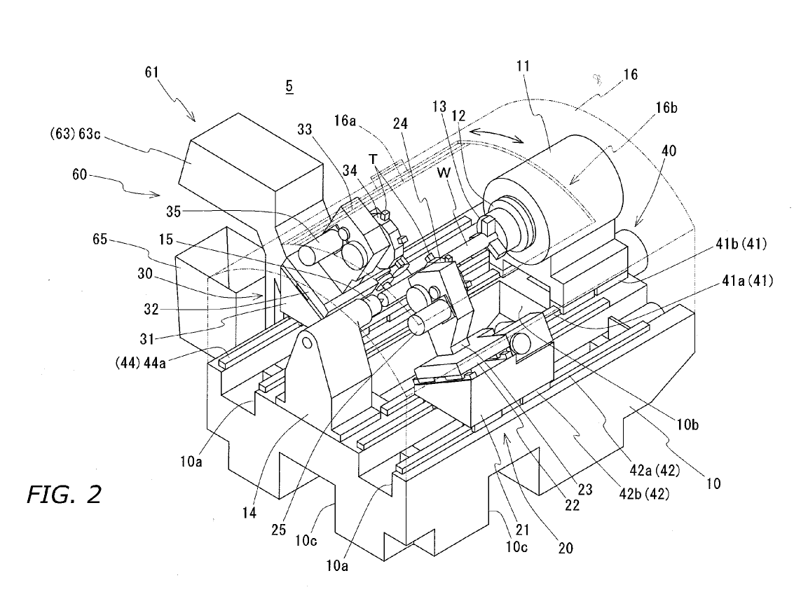

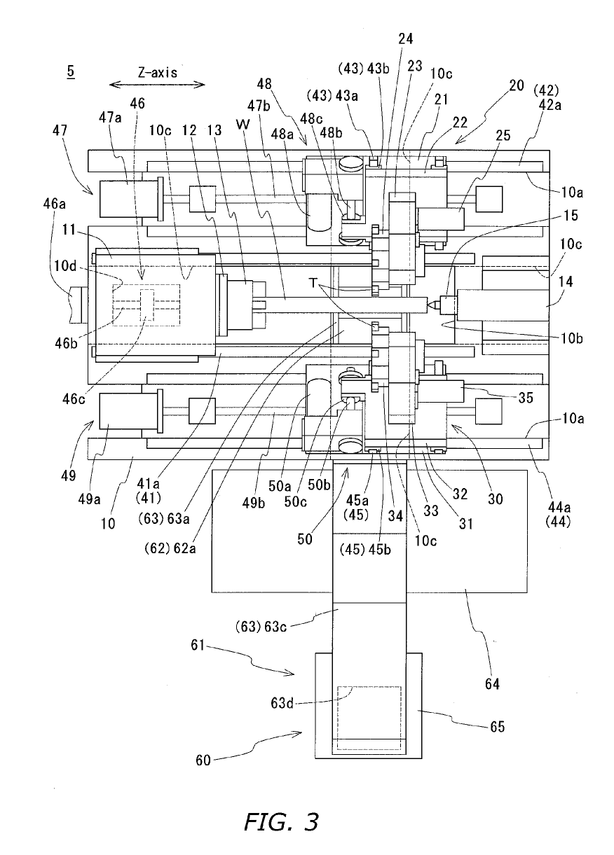

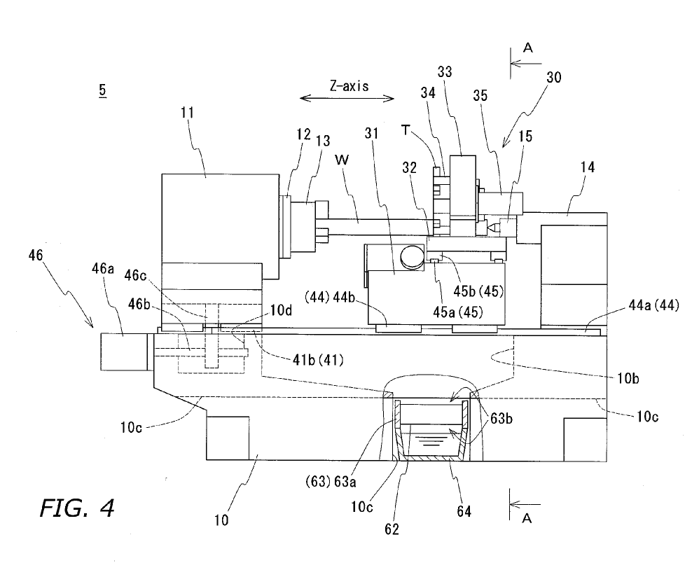

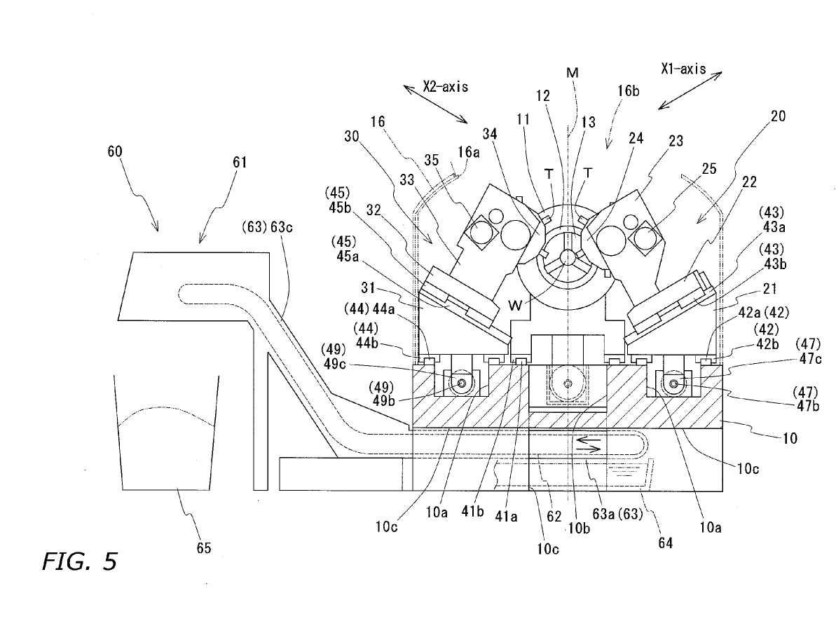

Preferred embodiments of the invention are described next based on the appended drawings. It should be noted that FIG. 1 is a perspective view schematically showing the configuration of the machining system according to an embodiment of the invention. FIG. 2 is a perspective view schematically showing the lathe according to this embodiment, FIG. 3 is a plan view of the lathe shown in FIG. 2, FIG. 4 is a front view of the lathe shown in FIG. 2, and FIG. 5 is a cross section taken in the arrow A-A direction in FIG. 4.

As shown in FIGS. 1 through 5, a machining system 1 of the invention is provided with two lathes 5 (first lathe 5a and second lathe 5b), each of which is made of a rectangular bed 10, a main spindle 12 whose axis is horizontal and parallel to the lengthwise direction of the bed 10, a headstock 11 that supports the main spindle 12 in such a manner that the main spindle 12 can rotate about its axis, and that is disposed on the upper face of the bed 10 in such a manner that it can move in the axial direction of the main spindle 12 (in the Z-axis direction), a tailstock 14 that is fixedly disposed on the upper face of a longitudinal end portion of the bed 10 in opposition to the headstock 11, a tailstock spindle 15 that is supported coaxial to the main spindle 12 axis by the tailstock 14, and first and second tool posts 20 and 30 that are disposed on the upper face of the width direction ends of the bed 10 in such a manner that they can move in the axial direction of the main spindle 12 (Z-axis direction) and in a direction perpendicular to this (X1-axis, X2-axis direction), and a conveying device 70 for conveying workpieces W to the lathes 5. As regards the lathes 5, they are arranged so that they face one another at their bed 10 face on the tailstock 14 side and so that the axes of their main spindles 12 are coaxial.

In addition to the above, each lathe 5 further includes a movement mechanism 40 for moving the headstock 11, the first tool post 20, and the second tool post 30 in the various directions, a collection device 60 for collecting the chips produced by the cutting, a cover member 16 that surrounds the headstock 11, the tailstock 14, the first tool post 20, the second tool post 30, and the upper face of the bed 10, and a control device (not shown) for controlling the operation of the movement mechanism 40 and the collection device 60, for example.

The external shape the bed 10 in a vertical cross section in its width direction is formed with left and right symmetry with respect to a predetermined vertical plane of symmetry M, recessed portions 10a are formed in the Z-axis direction in its upper face on both ends in the width direction, and the headstock 11 and the tailstock 14 are disposed on the upper surface of the bed 10 in the center in the width direction so that the axes of the main spindle 12 and the tailstock spindle 15 are in the plane of symmetry M.

The bed 10 is also provided with a chip discharge hollow 10b that is formed as a long opening in the upper surface of the bed 10 between the headstock 1I1 and the tailstock 14 (that is, in the center of the bed 10 upper face), whose lengthwise direction is in the main spindle 12 axial direction, and that passes through the bed 10 in the vertical direction, and four insertion recesses 10c formed in the horizontal direction, one side of each in communication with a lower portion of the chip discharge hollow 10b and the other side of each open to one of the four lateral faces of the bed 10.

It should be noted that the insertion recesses 10c provided in the lateral faces in the lengthwise direction of the bed 10 are formed on the same line parallel to the lengthwise direction of the bed 10, and similarly, the insertion recesses 10c provided in the lateral faces in the width direction of the bed 10 are formed on the same line parallel to the width direction of the bed 10. The width of the opening of the chip discharge hollow 10b on its lower portion side in the lengthwise direction is formed small, and has substantially the same width as the opening, in the lengthwise direction of the bed 10, of the insertion recesses 10c provided in the width direction lateral faces of the bed 10.

The headstock 11 is integrally provided with a rotational drive device (not shown), whose operation is controlled by the control device (not shown), for rotating the main spindle 12 about its axis, and a chuck 13 for grasping the one end side of the workpiece W is mounted to the main spindle 12. The other end side of the workpiece W is supported by the tailstock spindle 15.

The first tool post 20 is provided with a first saddle 21 that is disposed on the upper face of the bed 10 between one end face of the bed 10 in the width direction and the chip discharge hollow 10b in such a manner that it can move in the Z-axis direction and its upper face is slanted toward the chip discharge hollow 10b so as to be parallel to the X1-axis direction, a second saddle 22 that is disposed on the upper face of the first saddle 21 in such a manner that it can move in the X1-axis direction, a main tool post unit 23 that is disposed on the second saddle 22, a multigonal turret 24 that is supported by the main tool post unit 23 in such a manner that it can rotate about a rotation axis that is parallel to the main spindle 12 axis, a plurality of tools T mounted to its outer peripheral face, and an indexing mechanism 25 that rotates the turret 24 about its rotational axis to index a predetermined tool T at a predetermined machining position, under control by the control device (not shown).

The second tool post 30, like the first tool post 20, is provided with a first saddle 31, a second saddle 32, a main tool post unit 33, a turret 34, and an indexing mechanism 35, but the first saddle 31 is disposed on the upper face of the bed 10 between its lateral face on the other side of the bed 10 in the width direction and the chip discharge hollow 10b in such a manner that it can move in the Z-axis direction, and its upper face is slanted toward the chip discharge hollow 10b so as to be parallel to the X2-axis direction, and the second saddle 32 is disposed on the upper surface of the first saddle 31 in a manner that allows movement in the X2-axis direction.

The movement mechanism 40 is provided with a first guide device 41 for guiding movement of the headstock 11, a second guide device 42 for guiding movement of the first saddle 21 of the first tool post 20, a third guide device 43 for guiding movement of the second saddle 22 of the first tool post 20, a fourth guide device 44 for guiding movement of the first saddle 31 of the second tool post 30, a fifth guide device 45 for guiding movement of the second saddle 32 of the second tool post 30, a first feed device 46 for driving the headstock 11, a second feed device 47 for driving the first saddle 21 of the first tool post 20, a third feed device 48 for driving the second saddle 22 of the first tool post 20, a fourth feed device 49 for driving the first saddle 31 of the second tool post 30, and a fifth feed device 50 for driving the second saddle 32 of the second tool post 30.

The first guide device 41 is made of guide rails 41 a that are disposed in the Z-axis direction on the upper surface of the bed 10 on both sides of the chip discharge hollow 10b, and sliders 41b that are fixedly provided on the bottom surface of the headstock 11 and that moveably engage the guide rails 41a.

The second guide device 42 and the fourth guide device 44 are made of guide rails 42a and 44a that are disposed in the Z-axis direction on the upper surface of the bed 10 on either side of the recessed portions 10a, and sliders 42b and 44b that are fixedly provided on the bottom face of the first saddles 21 and 31 and that moveably engage the guide rails 42a and 44a, and the third guide device 43 and the fifth guide device 45 are made of guide rails 43a and 45a that are disposed in the X1-axis or the X2-axis on the upper surface of the first saddles 21 and 31, and sliders 43b and 45b that are fixedly provided on the bottom face of the second saddles 22 and 32 and that moveably engage the guide rails 43a and 45a.

The first feed device 46 is made of a drive motor 46a that is fixedly provided on the bed 10, a ball screw 46b that is arranged in the Z-axis spanning the recessed portion 10d that is formed in the upper surface of the bed 10 below the headstock 11, and that is rotated about its axis by the drive motor 46a, and a nut 46c that is disposed within the recessed portion 10d, fixedly provided on the bottom face of the headstock 11, that meshes with the ball screw 46b.

The second feed device 47 and the fourth feed device 49 are made of drive motors 47a and 49a that are contained within the recessed portions 10a in the width direction end portions of the bed 10, ball screws 47b and 49b that are disposed in the Z-axis within the recessed portions 10a and that are rotated about their axes by the drive motors 47a and 49a, and nuts 47c and 49c that are disposed in the recessed portions 10a, fixedly provided on the bottom faces of the first saddles 21 and 31, that mesh with the ball screws 47b and 49b, and the third feed device 48 and the fifth feed device 50 are made of drive motors 48a and 50a that are fixedly provided on the upper surface of the first saddles 21 and 31, ball screws 48b and 50b that are disposed in the X1-axis or the X2-axis on the upper surface of the first saddles 21 and 31 and that are rotated about their axes by the drive motors 48a and 50a, and nuts 48c and 50c that are disposed on the lateral faces of the first saddles 21 and 31 and that mesh with the ball screws 48b and 50b.

In this way, with the guide devices 41, 42, 43, 44, and 45 and the feed devices 46, 47, 48, 49, and 50, the drive motors 46a, 47a, 48a, 49a, and 50a are driven and rotate the ball screws 46b, 47b, 48b, 49b, and 50b about their axes, moving the nuts 46c, 47c, 48c, 49c, and 50c in conjunction with this, at which time the headstock 11 and the first saddles 21 and 31 are guided in the Z-axis direction, and the second saddles 22 and 32 are guided in the X1-axis direction or the X2-axis direction, by the guide rails 41a, 42a, 43a, 44a, and 45a and the sliders 41b, 42b, 43b, 44b, and 45b. It should be noted that the operation of the drive motors 46a, 47a, 48a, 49a, and 50a of the feed devices 46, 47, 48, 49, and 50 is controlled by the control device (not shown).

The collection device 60 is provided with a discharge mechanism 61 for conveying the chips in a predetermined conveying direction and discharging them to the outside, a storage tank 64, disposed below the discharge mechanism 61 on the conveying direction upstream side, that stores cutting fluid, and a collection box 65 that is disposed below the discharge mechanism 61 on the conveying direction downstream end.

The discharge mechanism 61 is made of a conveyor belt 62 for conveying chips that is endlessly engaged between a plurality of plates 62a, a support member 63 that contains and rotatively supports the conveyor belt 62, and a drive motor (not shown) whose operation is controlled by the control device (not shown) and that rotatively drives the conveyor belt 62 in the arrow direction (see FIG. 5).

The support member 63 is made of a horizontal portion 63a and a slanted portion 63c. The front end portion of the horizontal portion 63a (its end portion upstream in the conveying direction) is inserted through the bed 10 lateral face opening of the insertion recess 10c, of the four insertion recesses 10c, that is provided in the bed 10 lateral face on the second tool post 30 side (in the case of the second lathe 5b) or is inserted through the bed 10 lateral face opening of the insertion recess 10c, of the four insertion recesses 10c, that is provided in the bed 10 lateral face on the first tool post 20 side (in the case of the first lathe 5a), and disposed below the chip discharge hollow 10b, and the slanted portion 63c is disposed outside the lathes 5.

A vertical opening is formed in the horizontal portion 63a, and through this opening 63b the chips and cutting fluid fall on the conveyor belt 62, and the cutting fluid that falls onto the conveyor belt 62 flows even further below the opening 63b (into the storage tank 64, which is described later). The lower face of the slanted portion 63c downstream in the conveying direction is open, and the chips that have been conveyed by the conveyor belt 62 fall from this opening 63d and collect in the collection box 65. The storage tank 64 is inserted through the bed 10 lateral face opening of the same insertion recess 10c as the horizontal portion 63a of the support member 63, and is disposed below the horizontal portion 63a, and stores the cutting fluid that flows downward from the conveyor belt 62.

In this way, with the collection device 60, the chips and cutting fluid fall onto the conveyor belt 62, which is being rotated by the drive motor (not shown), from the chip discharge hollow 10b, and the chips land on the conveyor belt 62 and are conveyed toward the outside of the lathe 5 and drop into and are collected in the collection box 65 at the downstream end in the conveying direction. On the other hand, the cutting fluid flows off the conveyor belt 62 and is stored in the storage tank 64.

It should be noted that a cover (not shown) is suitably attached to the bed 10, the first saddles 21 and 31, and the second saddles 22 and 32 in order to cover the guide devices 41, 42, 43, 44, and 45 and the feed devices 46, 47, 48, 49, and 50, etc., of the movement mechanism 40, and this cover helps guide the chips and the cutting fluid to the chip discharge hollow 10b.

The cover member 16 separates the inside from the outside of the lathe 5 and prevents chips and cutting fluid from spattering outside, is provided with a shutter-type door 16a for forming an opening 16b in the upper face of the cover member 16 and slides in the arrow direction (see FIG. 2) toward the first tool post 20 in the case of the first lathe 5a and toward the second tool post 30 in the case of the second lathe 5b, and an open/close mechanism (not shown) whose operation is controlled by the control device (not shown) and that slides the door 16a to open and close it.

The door 16a is provided so that the cover member 16 can be opened when workpieces W are transported in and out by the conveying device 70 and when the operator performs various tasks, such as when changing the tools T that are mounted to the tool posts 20 and 30. It should be noted that the bed 10 is set to a low height and the overall height of the lathes 5 is set low so that the operator can perform tasks through the opening 16b in the upper portion of the cover member 16 with ease.

The opening 16b is formed spanning an area from above the first tool post 20 to an area above the second tool post 30 and also spanning an area above the headstock 11 to an area above the tailstock 14, and moreover, is formed in such a manner that the distances from the opening end faces on either side in the width direction to the bed 10 the plane of symmetry M are equal.

The open/close mechanism (not shown) is activated under control by the control device (not shown) when workpieces W are transported in or out by the conveying device 70, and when actuated by an operator, and slides the door 16a to open the cover member 16.

The conveying device 70 is provided with a grasping mechanism 71 for grasping workpieces W, a raising/lowering mechanism 72 for raising and lowering the grasping mechanism 71 up and down, a moving member 73 that supports the raising/lowering mechanism 72, a guide member 74 disposed above the lathes 5, its lengthwise direction parallel to the main spindle 12 axis, for movably supporting the moving member 73 in its lengthwise direction (the direction of the arrow in FIG. 1), a drive mechanism (not shown) for moving the moving member 73 in the lengthwise direction of the guide member 74, a first workpiece placing portion (not shown), provided outside the lathes 5, on which unmachined workpieces W are placed, a second workpiece placing portion (not shown), provided outside the lathes 5, on which machined workpieces W are placed, and a control portion (not shown) for controlling the operation of the grasping mechanism 71, the raising/lowering mechanism 72, and the drive mechanism (not shown).

The conveying device 70 controls the operations of the grasping mechanism 71, the raising/lowering mechanism 72, and the drive mechanism (not shown) with the control portion (not shown), to perform a first operation of grasping a workpiece W on the first workpiece placing portion (not shown) with the grasping mechanism 71 and conveying it so that it is held by the chuck 13 of the main spindle 12 of the first lathe 5a, a second operation of grasping the workpiece W that is held by the chuck 13 of the first lathe 5a with the grasping mechanism 71 and conveying it so that it is held by the chuck 13 of the main spindle 12 of the second lathe 5b, and a third operation of grasping the workpiece W that is held by the chuck 13 of the second lathe 5b with the grasping mechanism 71 and conveying it to the second workpiece placing portion (not shown).

The conveying device 70 lowers the grasping mechanism 71 to a lowered end position with the raising/lowering mechanism 72 when grasping the workpiece W with the grasping mechanism 71 or when releasing a workpiece W that has been grasped by the grasping mechanism 71, and raises the grasping mechanism 71 to a raised end position with the raising/lowering mechanism 72 when moving the moving member 73 with the drive mechanism (not shown).

It should be noted that the control portion (not shown), when executing the first operation, opens the door 16a of the first lathe 5a with the open/close mechanism (not shown) via the control device (not shown) of the first lathe 5a, when executing the second operation, opens the doors 16a with the open/close mechanisms (not shown) via the control devices (not shown) of the first lathe 5a and the second lathe 5b, and when executing the third operation, opens the door 16a of the second lathe 5b with the open/close mechanism (not shown) via the control device (not shown) of the second lathe 5b.

With the machining system 1 of this example having the above configuration, first the conveying device 70 performs the first operation of grasping an unmachined workpiece W on the first workpiece placing portion (not shown) with the grasping mechanism 71 and conveying it so that it is held by the chuck 13 of the main spindle 12 of the first lathe 5a, and the headstock 11 is moved in the Z-axis direction by the first feed device 46 of the first lathe 5a, and by doing this, one end of the workpiece W is held by the chuck 13 and the other end of the workpiece W is supported by the tailstock spindle 15, thus sandwiching the workpiece W between the chuck 13 and the tailstock spindle 15. At this time, the door 16a of the first lathe 5a is opened by the open/close mechanism (not shown) when the workpiece W is transported into the first lathe 5a.

It should be noted that the order in which the workpiece W is held by the chuck 13 and the tailstock spindle 15 is not limited to this, and for example it is also possible to first have the chuck 13 grasp one end of the workpiece W and then to move the headstock 11 in the Z-axis direction with the first feed device 46 to abut and push the other end of the workpiece W against the tailstock spindle 15, thereby sandwiching the workpiece W between the chuck 13 and the tailstock spindle 15, or first press the other end side of the workpiece W against the tailstock spindle 15 and then move the headstock 11 in the Z-axis direction with the first feed device 46 to cause the chuck 13 to grasp the one end side of the workpiece W, thereby sandwiching the workpiece W between the chuck 13 and the tailstock spindle 15.

Next, the rotational drive device (not shown) rotates the main spindle 12 about its axis to rotate the workpiece W, and the second feed device 47, the third feed device 48, the fourth feed device 49, and the fifth feed device 50 move the first tool post 20 and the second tool post 30 in the Z-axis direction, the X1-axis direction, and the X2-axis direction, thereby machining a predetermined region of the outer circumference surface on the other end side (tailstock spindle 15 side) of the workpiece W into a predetermined shape. It should be noted that at the time of this machining, a predetermined tool T of the plurality of tools T that are mounted to the turrets 24 and 34 of the tool posts 20 and 30 has been pre-indexed to a predetermined machining position by the indexing mechanism 25 or 35.

Then, the conveying device 70 performs the second operation of grasping the workpiece W that is being held by the chuck 13 of the first lathe 5a with the grasping mechanism 71 and conveying it so that the workpiece W is held by the chuck 13 of the main spindle 12 of the second lathe 5b, and the first feed device 46 of the second lathe 5b moves the headstock 11 in the Z-axis direction, and these cause the other end side of the workpiece W to be held by the chuck 13 and the one end side to be supported by the tailstock spindle 15, sandwiching the workpiece W between the chuck 13 and the tailstock spindle 15. At this time, the doors 16a are opened by the open/close mechanism (not shown) when the workpiece W is transported from the first lathe 5a and when it is transported into the second lathe 5b.

Then, in the same way as above, when the main spindle 12, the chuck 13, and the workpiece W all are rotated about their axes and the first tool post 20 or the second tool post 30 is moved in the Z-axis direction, the X1-axis direction, or the X2-axis direction, the unmachined region of the outer circumferential face on the one end side (tailstock spindle 15 side) of the workpiece W is machined into a predetermined shape. It should be noted that, like above, at the time of this machining a predetermined tool T of the plurality of tools T that are mounted to the turrets 24 and 34 of the tool posts 20 and 30 has been pre-indexed to a predetermined machining position by the indexing mechanism 25 or 35.

Next, the conveying device 70 performs the third operation of grasping the workpiece W that is being held by the chuck 13 of the second lathe 5b with the grasping mechanism 71 and conveying the workpiece W to the second workpiece placing portion (not shown). At this time, the door 16a of the second lathe 5b is opened by the open/close mechanism (not shown) when the workpiece W is transported from the second lathe 5b.

The workpiece W is thus machined in a series of operations, and when the workpiece W is transported from the first lathe 5a through the second operation of the conveying device 70, a new unmachined workpiece W is transported into the first lathe 5a through the first operation, and when the workpiece W is transported from the second lathe 5b through the third operation of the conveying device 70, a new workpiece W is transported into the second lathe 5b through the second operation.

It should be noted that the chips produced through this cutting and the cutting fluid that is suitably supplied to the point of contact between the tool T and the workpiece W pass through the chip discharge holow 10b down onto the conveyor belt 62, and the chips are conveyed into the collection box 65 by the conveyor belt 62 whereas the cutting fluid flows down off the conveyor belt 62 and stores in the storage tank 64.

With the lathes 5 of this example, the bed 10 has a rectangular shape and the distances from its lateral face on either side of the bed 10 in the width direction to its center (plane of symmetry M), that is, the distances to the axes of the main spindle 12 and the tailstock spindle 15, are equal, the lathes 5 are provided with a compact outer shape, and a tailstock 14, which has a simpler structure than the headstock 11 and whose shape is not as large, is fixedly provided on the upper face of the end portion of the bed 10, and thus operators can perform various tasks, such as attaching and detaching workpieces W, from the lengthwise direction lateral face of the bed 10 on the tailstock 14 side and from either side in the width direction of the bed 10. Thus, the efficiency with which the operator can perform these tasks in increased, and the limitations that are in effect when choosing how to arrange the lathes 5 are minimized, and this allows greater flexibility in how the lathes 5 are arranged.

Consequently, the machining system 1 of this example allows an operator to perform tasks from both sides in the width direction of the bed 10, and the lathes 5, whose beds 10 are formed in a shape that is rectangular when viewed from above, are arranged so that the tailstock 14 side lateral face of their beds 10 face one another and their main spindles 12 are coaxial, and thus by conveying the workpieces W with the conveying devices 70, the workpiece W end portion that is held by the chuck 13 and the workpiece W end portion that is supported by the tailstock spindle 15 in the first lathe 5a, and the workpiece W end portion that is held by the chuck 13 and the workpiece W end portion that is supported by the tailstock spindle 15 in the second lathe 5b, can be made opposite one another.

This obviates the need for a workpiece inverting device and thus allows production costs to be reduced, and also allows the overall size of the devices making up of the machining system 1 and the overall size of the configuration of the grasping mechanism 71 of the conveying device 70 to be kept small. It should be noted that operators can perform tasks from the second tool post 30 side of the bed 10 with the first lathe 5a and can perform tasks from the first tool post 20 side of the bed 10 with the second lathe 5b.

Also, since the tailstock 14 is fixedly provided on the bed 10 upper face and the tailstock 14 side of the beds 10 in opposition to one another, the distance between tailstocks 14 can be reduced so that the distance that the moving member 73 travels along the guide member 74 in longitudinal direction when the conveying device 70 executes the second operation can be shortened, and this allows the workpieces W to be conveyed in a shorter amount of time.

The lathes 5 of this example allow the following effects to be attained. That is, when performing maintenance on the lathes 5, the fact that the tailstock 14 is fastened to the bed 10 makes it possible to obviate maintenance of that section of the tailstock 14, therefore reducing the area that is to be maintenanced and allowing maintenance to be performed more efficiently.

Further, since the tailstock 14 that is fixedly provided on the bed 10 is less rigid than the headstock 11 and it is the headstock 11 that is moved, the rigidity of the tailstock 14 can be increased, and tilting of the tailstock spindle 15 axis and straining of the tailstock 14 due to the force when the other end side of the workpiece W is pressed against the tailstock spindle 15 are effectively prevented, and this allows the machining accuracy of the workpiece W to be increased.

Since four insertion recesses 10c that open to the four lateral faces of the bed 10 are provided, the insertion recess 10c into which the discharge mechanism 61 and the storage tank 64 of the collection device 60 are inserted can be suitably changed to fit the layout of the lathes 5 (machining system 1), and thus there is greater flexibility in the workplace layout of the lathes 5 (machining system 1).

Further, providing the cover member 16 allows the chips and the cutting fluid to be kept from spattering outside, and since the opening portion 16b of the cover member 16 is formed in such a manner that the distances from the opening edges on either side in the width direction of the bed 10 to the plane of symmetry M are equal, the operator can open the door 16a and perform tasks with ease from either side in the width direction of the bed 10.

One embodiment of the invention was described above, but the specific embodiments that the invention may take on are by no means not limited to this.

In the above example, the lathes 5a and 5b are disposed so that their bed 10 lateral faces on the tailstock 14 side are facing one another, but this is not a limitation, and it is also possible for the bed 10 lateral faces on the headstock 1I1 side to face one another.

The machining system 1 can also be made of three or more lathes 5, in which case at least two of those lathes 5 are disposed so that the bed 10 lateral faces on the tailstock 14 side face one another or so that the bed 10 lateral faces on the headstock 11 side face one another, as described above.

Further, in the above example, the discharge mechanism 61 and the storage tank 64 of the collection device 60 are inserted, in the case of the first lathe 5a, through the bed 10 lateral face side opening of the insertion recess 10c that is provided in the bed 10 lateral face on the first tool post 20 side, and in the case of the second lathe 5b, through the bed 10 lateral face side opening of the insertion recess 10c that is provided in the bed 10 lateral face on the second tool post 30 side; however, there is no limitation to this, and for example it is also possible for them to be inserted through any of the other insertion recesses 10c, such as the bed 10 lateral face opening of the insertion recess 10c that is provided in the bed 10 lateral face on the headstock 11 side.

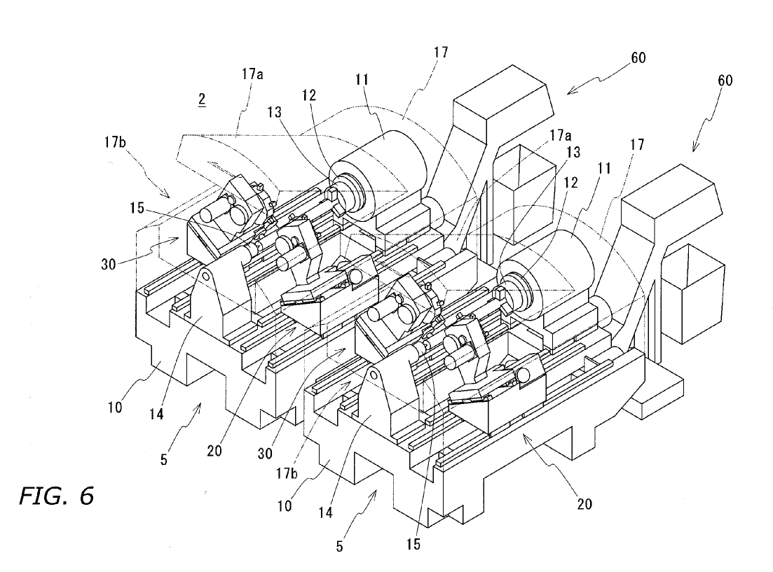

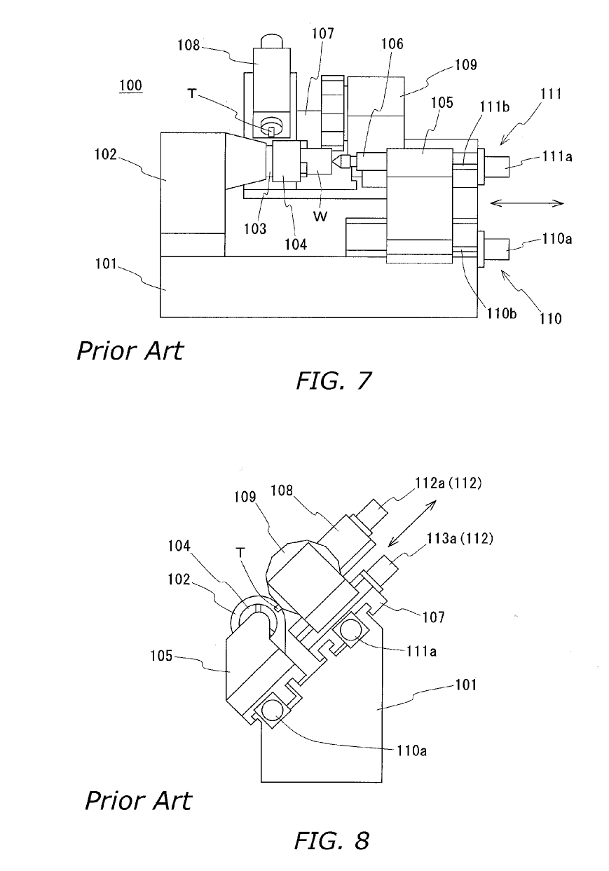

The machining system 1 in the above example is made of two lathes 5 (the first lathe 5a and the second lathe 5b) and the conveying device 70 for conveying workpieces W to the lathes 5, but as shown in FIG. 6, it is also possible to achieve a machining system 2 by positioning the two lathes 5 in parallel.

In this case, the lathes 5 are arranged so that the axes of their main spindles 12 are in parallel with a predetermined distance between them, and so that the bed 10 lateral face on the first tool post 20 side of one lathe 5 is facing the bed 10 lateral face on the second tool post 30 side of the other lathe 5.

The front end portion (end portion on the conveying direction upstream side) of the horizontal portion 63a of the support member 63 of the discharge mechanism 61 is inserted from the insertion recess 10c, of the four insertion recesses 10c, that opens to the end portion lateral face on the headstock 11 side in the bed 10 longitudinal direction and is disposed below the chip discharge hollow 10b. Similarly, the storage tank 64 also is inserted from the same insertion recess 10c and is disposed below that horizontal portion 63a.

A cover member 17 is provided in place of the cover member 16, and the cover member 17 is provided with a door 17a that opens upward about an axis that is parallel to the bed 10 width direction and that is for forming an opening 17b in the cover member 17 upper face and in the lateral face of the cover member 17 on the tailstock 14 side.

The door 17a is provided so that the operator can open the door 17a and perform various tasks, such as attaching and detaching workpieces W, through the opening 17b, and the door 17a when opened is supported by a suitable support mechanism (not shown) that keeps it from closing.

The opening 17b is formed spanning from the cover member 17 lateral face on the tailstock 14 side to the cover member 17 upper face on the headstock 1I1 side in such a manner that that the distances from the opening edges in the bed 10 width direction to the plane of symmetry M are equal.

As described above, this machining system 2 allows an operator to perform work from the tailstock 14 side lateral face of the bed 10 as well, and since the two lathes 5, each of which has a bed 10 that is formed in a rectangular shape, are disposed in parallel in such a manner that the axes of their main spindles 12 are parallel to one another with a predetermined spacing between them, the spacing between the lathes 5 can be made suitably narrow, and by reducing the spacing between the lathes 5 it is possible to reduce the area of the region in which the machining system 2 is installed.

With the lathes 5 of the machining system 2, the door 17a of the cover member 17 is formed spanning from the cover member 17 lateral face on the tailstock 14 side to the cover member 17 upper face on the headstock 1I1 side in such a manner that the distances from the opening end faces in the bed 10 width direction to the plane of symmetry M are equal, and thus the operator can open the door 17a and perform tasks easily from either lateral face in the width direction of the bed 10 and the lateral face on the tailstock 14 side in the bed 10 lengthwise direction, and this allows the operator to perform work tasks efficiently.

It should be noted that the machining system 2 is made of two lathes 5, but this is not a limitation, and it can also be made of three or more lathes 5.

In the machining system 2, the discharge mechanism 61 and the storage tank 64 of the collection device 60 are inserted from the insertion recess 10c on the headstock 11 side in the bed 10 lengthwise direction, but this is not a limitation, and for example it is also possible to insert them from any of the other insertion recesses 10c, such as inserting them from the insertion recess 10c on the side opposite the side facing the adjacent lathe 5.

In the machining system 2, the two lathes 5 are arranged in parallel so that their headstocks 1I1 and their tailstocks 14 are adjacent, but this is not a limitation, and it is also possible for the two lathes 5 to be disposed in parallel such that the headstock 11 of one lathe 5 and the tailstock 14 of the other lathe 5 are adjacent to the tailstock 14 of the one lathe 5 and to the headstock 11 of the other lathe 5, respectively, and by doing this, it is not necessary to invert the workpiece W when conveying and mounting a workpiece W that has been machined by one of the lathes 5 to the other lathe 5 using a suitable conveying/mounting device (loading/unloading device) such as a loader, and thus the system configuration can be simplified.

In the machining systems 1 and 2, it is also possible to omit the discharge mechanism 61 and the storage tank 64 from the collection device 60 so that the collection device 60 is made of only the collection box 65, and to then dispose the collection box 65 below the chip discharge hollow 10b.

With regard to holding the workpiece W with the chuck 13 of the main spindle 12 and the tailstock spindle 15, the other end side of the workpiece W is supported by the tailstock spindle 15 of the tailstock 14 due to the thrusting force of the drive motor 46a of the first feed device 46, but this is not a limitation, and it is also possible to provide a suitable hydraulic mechanism for moving the tailstock spindle 15 in the axial direction and for that hydraulic mechanism to move the tailstock spindle 15 toward the main spindle 12 to push it against the other end side of the workpiece W with a predetermined force and thereby support the other end side of the workpiece W.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A lathe comprising:
a bed;
a headstock installed on said bed;
a main spindle, supported by said headstock such that the main spindle axis is horizontal, and allowing the main spindle to rotate on the axis as center, said main spindle for holding a workpiece along one end thereof;
a rotational drive mechanism for rotating said main spindle on its axis as center;
a tailstock arranged on said bed in opposition to said headstock;
a tailstock spindle, supported by said tailstock such that it is coaxial with said main spindle axis, for supporting the workpiece along the other end thereof;
a tool post for holding tools, arranged on said bed so as to be moveable along said main spindle axis and so as to be moveable perpendicular to said main spindle axis; and
a tool post feed mechanism for moving said tool post in each of said directions; wherein
said headstock is configured to be moveable along said main spindle axis, whereas said tailstock is fixedly installed on said bed; and
said headstock is configured for being moved along said main spindle axis by a headstock feed mechanism.

2. The lathe according to claim 1, wherein:
said bed is formed rectangularly in overhead view, and is formed with at least the external conformation of a vertical section widthwise through said bed being symmetrical on either side of a predetermined vertical plane of symmetry; and
said headstock and said tailstock are arranged on the upper surface of said bed such that the axes of said main spindle and said tailstock spindle are included in the plane of symmetry.

3. The lathe according to claim 2, wherein said bed is provided with a chip discharge hollow formed vertically and opening in said bed upper surface between said headstock and said tailstock, and is provided with four insertion recesses formed extending horizontally, one side of each communicated with the lower part of the chip discharge hollow, and the other side of each open on one of the lateral sides of said bed; therein further comprising:
a chip collection means for collecting chips, said chip collection means inserted through any one of the bed-lateral-side openings in the four insertion recesses to dispose said chip collection means beneath the chip discharge hollow.

4. The lathe according to claim 3, further comprising a cover member surrounding said headstock, said tailstock, said tool post, and at least said bed upper surface, said cover member being furnished in its upper surface with a door for forming an opening.

5. The lathe according to claim 4, wherein the opening in said cover member is formed such that the distances to the plane of symmetry from the endfaces on either side of the opening in the bed widthwise orientation are equal, and is formed extending from the above said tailstock to the opposite side thereof.

6. A machining system equipped with at least a first lathe according to claim 2, and a second lathe according to claim 2, wherein:
the lathes are disposed rowed in parallel such that their main spindles axes are parallel and spaced apart by a predetermined distance.

7. A machining system equipped with at least a first lathe according to claim 3, and a second lathe according to claim 3, wherein:
the lathes are disposed rowed in parallel such that their main spindles axes are parallel and spaced apart by a predetermined distance.

8. A machining system equipped with at least a first lathe according to claim 4, and a second lathe according to claim 4, wherein:
the lathes are disposed rowed in parallel such that their main spindles axes are parallel and spaced apart by a predetermined distance.

9. A machining system equipped with at least a first lathe according to claim 5, and a second lathe according to claim 5, wherein:
the lathes are disposed rowed in parallel such that their main spindles axes are parallel and spaced apart by a predetermined distance.

10. A machining system comprising:
two lathes, a first lathe and a second lathe, each configured as set forth in claim 2; and
a conveying device, furnished with a grasping mechanism for grasping workpieces, said conveying device for moving said grasping mechanism in three-dimensional space to convey workpieces to said lathes; wherein
said first lathe and said second lathe are disposed with either the lateral sides of the beds on the headstock side of each or the lateral sides of the beds on the tailstock side of each facing each other, and such that the axes of their respective main spindles are coaxial; and
said conveying device is configured to perform:
a first operation of grasping with said grasping mechanism a workpiece outside said first lathe and conveying the workpiece so as to allow the workpiece to be held by the main spindle of said first lathe;
a second operation of grasping with said grasping mechanism the workpiece held by the main spindle of said first lathe and conveying the workpiece so as to allow the workpiece to be held by the main spindle of said second lathe; and
a third operation of grasping with the grasping mechanism the workpiece held by said second lathe and conveying the workpiece to outside said second lathe.

11. The machining system according to claim 10, wherein:
each bed is provided with a chip discharge hollow formed vertically and opening in the bed upper surface between the headstock and the tailstock, and three insertion recesses formed extending horizontally, one side of each communicated with the lower part of the chip discharge hollow, and the other side of each open on one of the bed lateral sides except at least the lateral sides along which the beds oppose each other; and
each lathe is further provided with a chip collection means for collecting chips, said chip collection means inserted through any one of the bed-lateral-side openings in the three insertion recesses to dispose said chip collection means beneath the chip discharge hollow.

12. The machining system according to claim 11, wherein
each lathe further comprises a cover member surrounding the headstock, the tailstock, the tool post, and at least the bed upper surface, each cover member being furnished in its upper surface with a openable/closable door for forming an opening, and with an open/close mechanism for opening and closing the door; and
the open/close mechanism of said first lathe is configured so as to open the door during the first operation and the second operation by said conveying device, and the open/close mechanism of said second lathe is configured so as to open the door during the second operation and the third operation by said conveying device.

13. The machining system according to claim 12, wherein the opening in each of said cover members is formed such that the distances to the plane of symmetry from the endfaces on either side of the opening in the bed widthwise orientation are equal.

14. The machining system according to claim 10, wherein said first lathe and said second lathe are disposed such that the lateral sides of the beds on the tailstock side of each face each other.

15. The machining system according to claim 11, wherein said first lathe and said second lathe are disposed such that the lateral sides of the beds on the tailstock side of each face each other.

16. The machining system according to claim 12, wherein said first lathe and said second lathe are disposed such that the lateral sides of the beds on the tailstock side of each face each other.

17. The machining system according to claim 13, wherein said first lathe and said second lathe are disposed such that the lateral sides of the beds on the tailstock side of each face each other.
